(19) United States
(12) Patent Application Publication
(10) Pub. No.: US 2003/0131054 A1
(43) Pub. Date: Jul. 10, 2003

(54) CORBA based transmission element management system and method

(75) Inventor: Myoung-Kyu Sohn, Kyounggi-Do (KR)

Correspondence Address: FLESHNER & KIM, LLP, P.O. Box 221200, Chantilly, VA, 20153-1200, US

(73) Assignee: LG Electronics Inc,

(21) Appl. No.: 10/329,708

(22) Filed: Dec. 27, 2002

(30) Foreign Application Priority Data
Dec. 29, 2001 (KR) 87737/2001

(51) Int. Cl. G06F 15/16

(52) U.S. Cl. 709/203

(57) ABSTRACT

A Common Object Request Broker Architecture (CORBA) based transmission element management system and method thereof. More specifically, generating CORBA objects in respective transmission elements in which commands will be executed when the commands for managing a plurality of transmission elements which are remotely connected are received from a client, and transmits the command to respective transmission elements using the CORBA object, and the result value that the commands are executed by the respective transmission element is reported to the client through the CORBA objects in the respective transmission elements. Also, the present invention collects alarms which are generated in a plurality of transmission elements using a channel for providing a notification service of the CORBA. Therefore, the present invention can process the command from the client without blocking and collect alarm information from the plurality of transmission elements without blocking, so that one EMS can efficiently and stably manage the plurality of transmission elements which are remotely connected.

### BACKGROUND OF THE INVENTION

1. Field of the Invention

The present invention relates to an Element Management System, and more particularly to a Common Object Request Broker Architecture (CORBA) based transmission element management system.

2. Background of the Related Art

Generally, a system for managing a network has either a three step hierarchy or a two step hierarchy. The three step hierarchy consists of Network Management System (NMS)-Element Management System (EMS)-Craft Interface Terminal (CIT), while the two step hierarchy consists of NMS-EMS.

The NMS is an uppermost level of a management system and is composed using a plurality of workstations. The CIT is a terminal for operating and managing one or more elements. The EMS is composed using a personal computer or a small workstation, and is a system for operating and managing one or more elements. The two step system is configured to absorb the functions of the CIT.

To efficiently manage a network, information on the operational state of the Network Element (NE) (or a transmission apparatus) that composes the respective nodes is collected, and from that a database is constructed. Thus, the state information of the network element (or transmission element) is reported to the EMS, and the EMS stores the information in the database by collecting the information. The EMS additionally performs reporting to the upper level, if necessary.

The system operator can recognize and manage the state of each node by searching a database of the EMS using a user interface.

The related art transmission element system has various problems. For example, respective transmission elements are directly connected to the EMS or CIT. Consequently, the EMS or CIT which is directly connected with the transmission elements manages the transmission elements. Therefore, the related art element management system can only manage transmission elements that are connected to it and cannot control transmission elements that are remotely connected through the network.

Also, even if the EMS for controlling the plurality of transmission elements were implemented to solve the above problem, the load of the EMS would be increased when the system operator processed a command or alarm reporting. Accordingly, implementation of the system is not easy in the Transmission Control Protocol/Internet Protocol (hereinafter, as TCP/IP) network.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

Another object of the present invention is to provide a Common Object Request Broker Architecture (CORBA) based transmission element management system and method thereof, capable of managing a plurality of transmission elements which are remotely connected.

Another object of the present invention is to provide a CORBA based transmission element management system and method thereof, capable of efficiently and stably managing a plurality of transmission elements that are remotely connected to an EMS on the basis of the CORBA.

To achieve at least these objects, in whole or in parts, there is provided a CORBA based transmission element management system, including a plurality of transmission elements which are remotely connected on the basis of the CORBA, and an EMS for processing a control command by generating a CORBA object in each transmission element in which the control command from a client will be executed and managing the plurality of transmission elements.

Additionally, to achieve at least the above objects, in whole or in parts, there is provided a CORBA based transmission element management method, including the steps of receiving a command from a client, processing the command using a CORBA in each transmission element in which the command will be executed, and reporting to the client when the command execution result value is returned from the transmission element which receives the command.

Additionally, to achieve at least the above objects, in whole or in parts, there is provided a CORBA based transmission element management method, including the steps of generating a command processing CORBA object in each transmission element in which a request will be executed when a request for managing a plurality of transmission elements is received from a client to a command processing process, transmitting command information related to the command processing from the client to the command processing CORBA object, transmitting the command information from the command processing CORBA object to the message converting process, transmitting the command information from the message converting process to the corresponding transmission element by converting the command information into a message which can be recognized by the corresponding transmission element, and reporting to the client when the command execution result value is returned from the corresponding transmission element.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a drawing showing a structure of a Common Object Request Broker Architecture (CORBA) according to a preferred embodiment of the present invention;

FIG. 2 is a drawing showing a structure of command processing of an EMS according to the preferred embodiment;

FIG. 3 is a drawing showing a method of processing a command among CORBA objects;

FIG. 4 is a flow chart showing a CORBA based transmission element management method in accordance with the preferred embodiment of the present invention;

FIG. 5 is a drawing showing a structure of alarm processing of the EMS according to the preferred embodiment; and

FIG. 6 is a flow chart showing an alarm processing method of the EMS according to the preferred embodiment.

### DETAILED DESCRIPTION OF PREFERRED EMBODIMENTS

Reference will now be made in detail to the preferred embodiments of the present invention, examples of which are illustrated in the accompanying drawings.

The Internet, which has unified static data, is now rapidly developing a distributed object technology to construct a standard for information exchange and sharing with dynamic factors. The distributed object technology was constructed by grafting a distributed computing technology onto an object-oriented technology, and enables intercommunication among objects in a distributed environment.

The Common Object Request Broker Architecture (CORBA) is one of many distributed object technologies, and is becoming increasingly popular. CORBA is the standard specification of an Object Request Broker (ORB) defined by an Object Management Group (OMG). An ORB is a virtual system which is in charge of communication among objects under the distributed object circumstance.

The CORBA is thus a module that functions as a bus among different programs, just as a bus in a computer functions, and provides a function that can use a preferable object as if it were positioned locally, regardless of the actual location of the object.

The communication model between a CORBA client and an implementation object will be described as follows.

The communication is processed as the client who requires a service and the implementation object. The implementation provides service exchange requests (or commands) or service results (conversion values) through the ORB. The client first sends the name of the implementation object (i.e., the preferably name) and required contents to the ORB. The ORB then finds the implementation object based on the name, and transmits the required contents. When the implementation object returns the service result (conversion value) to the ORB, the ORB transmits it to the client.

Hereinafter, the CORBA object is defined as an object that communicates using the CORBA. The preferred embodiment of the present invention uses the CORBA to manage a plurality of transmission elements which are remotely connected to an EMS.

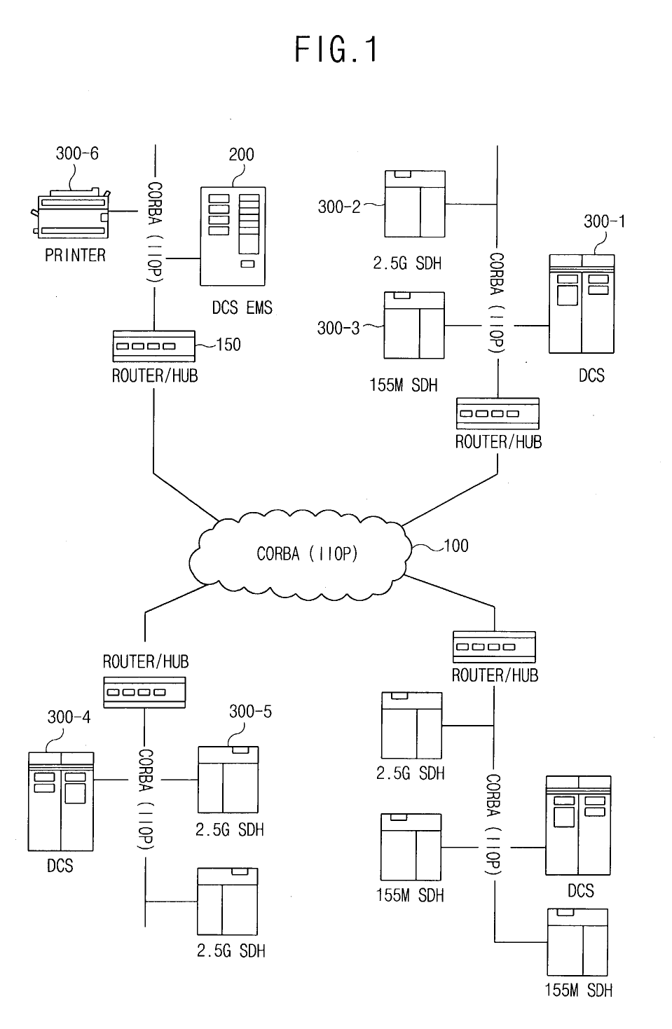

FIG. 1 is a drawing showing a structure of the CORBA in accordance with an embodiment of the present invention. As shown in FIG. 1, the CORBA based transmission element management system preferably includes a plurality of transmission elements 300-1˜300-n, which are remotely connected based on the CORBA, and an EMS 200 for managing the plurality of transmission elements 300-1˜300-n.

A basic protocol of the network is TCP/IP, the EMS 200, and the transmission elements 300-1˜300-n can be connected with each other using an ORB (not shown in FIG. 1) by performing Intern Inter-ORB Protocol (IIOP) communication of the CORBA 100 using TCP/IP. At this time, the plurality of transmission elements (for instance, a Digital Cross-connect System (DCS)) 300-1 and Synchronous Digital Hierarchy (hereinafter, as SDH) 300-2, 300-3 and the like support IIOP and are connected to the EMS 200 through at least one router or hub 150.

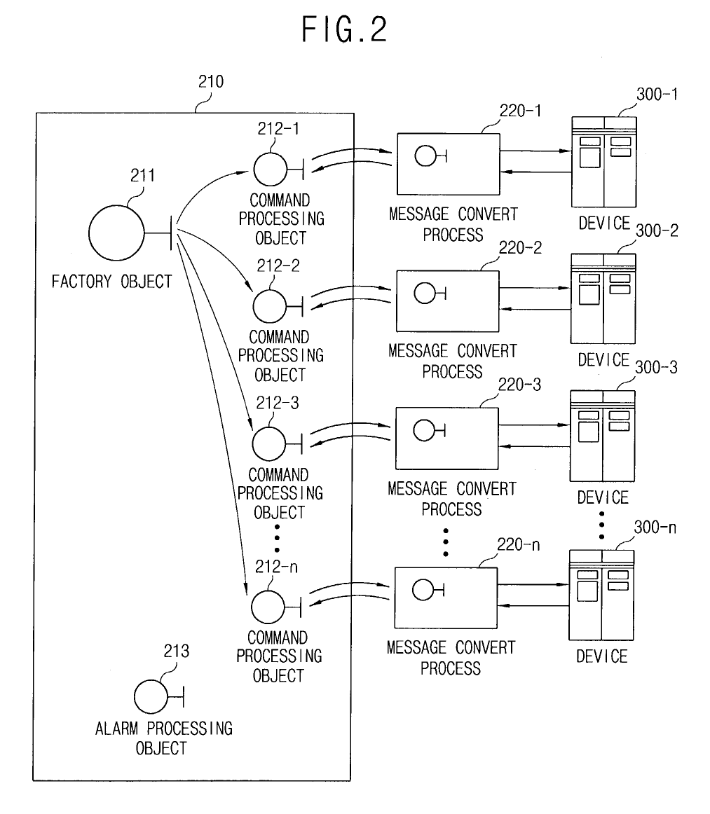

FIG. 2 is a drawing showing a structure of command processing of the EMS. As shown in FIG. 2, the EMS 200 preferably includes a command processing process 210 for generating command processing objects 212-1˜212-n. The command processing process processes the control command in respective transmission elements 300-1˜300-n. A control command from the client preferably is executed and a message converting processes 220-1˜220-n which are generated in the respective control command objects 212-1˜212-n, according to controlling of the command processing process 210, for transmitting a message to a corresponding transmission element after converting the control command to a message which is recognizable by the corresponding transmission element. The command processing process 210 also includes an alarm processing object 213, which will be discussed in more later.

The operation of the CORBA based transmission element management system and method thereof in accordance with a preferred embodiment of the present invention will be described with reference to the accompanied drawing.

The EMS 200 generates command processing objects 212-1˜212-n in respective transmission elements. Preferably there is a received control command must be executed when the control command is received from a client. Additionally, the control command generates message converting processes 220-1˜220-n in respective command processing objects 212-1˜212-n. Then, a control command, which is received from the client, is transmitted to the corresponding transmission element, which is remotely connected by the instrument processing object and message converting process. The transmission element, which receives the control command, returns the processing result to the message converting process after executing the corresponding command. The message converting process returns the returned processing result to the client through the command processing object.

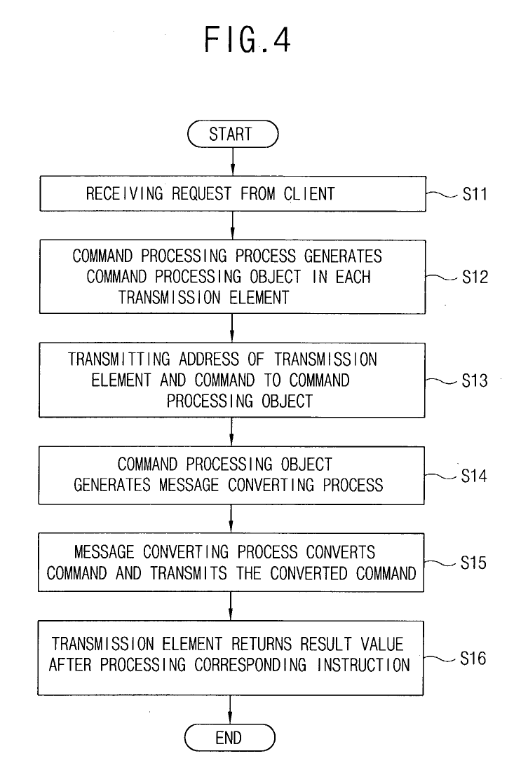

Additional detail regarding the above process will be described in more detail below. FIG. 4 is a flow chart showing the CORBA based transmission element management method in accordance with another embodiment of the present invention. FIG. 4 shows, a network operator inputs a request for control command through a User Interface (UI). The UI is provided by the EMS 200. Here, the client can be a client of the EMS 200 or an NMS (not shown in FIG. 1), which is an upper operation system of the EMS 200 (S11).

Alternatively, if a plurality of control commands are gathered in an EMS 200, to prevent control commands from being processed, the other control commands may be blocked until the control command is processed, the preferred embodiment of the present invention includes a method for executing the control command by generating a message converting process in each transmission element in which the control command must be executed using the function of the CORBA.

Consequently, when the requests are transmitted from the client to the command processing process 210 of the EMS 200, a factory object 211, of the command processing process 210, generates command processing objects 212-1˜212-n. The generated command processing objects are new CORBA objects in each transmission elements, wherein the requests must be executed, by analyzing requests of the client, and reports the generated command processing objects 212-1˜212-n to the client (S12).

The client then sends control commands such as address commands to be processed by the corresponding transmission element, and by the command processing objects 212-1˜212-n (S13). The command processing objects 212-1˜212-n generate message converting processes 220-1˜220-n one to one, and transmits a control command to the respective message converting processes 220-1˜220-n (S14).

Here, the message converting process is an execution file and is registered to the CORBA Implementation Repository. The EMS 200 in accordance with the preferred embodiment of the present invention registers the message converting process to the implementation repository so that different message converting processes are generated for different command processing objects. Thus, because a different converting process is generated, if the requested command processing object is different, the command processing object and message converting process are corresponded one to one.

Respective message converting processes 220-1˜220-n convert the transmitted control command into a recognizable message, by the corresponding transmission element, and transmit the converted message to the transmission element, (S15).

Respective transmission elements 300-1˜300-n, receive the control command to execute the control command and return the result to respective converting processes 220-1˜220-n. The respective message converting processes 220-1˜220-n transmits the returned result to the respective command processing objects 212-1˜212-n, and the respective command processing objects 212-1˜212-n transmit the returned result to the client (S16).

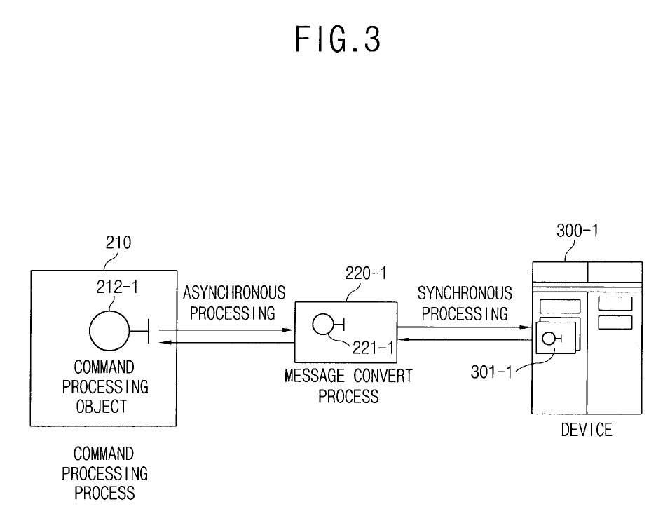

The process of a control command being executed will be described in additional detail below. As shown in FIG. 3, when a command processing object 212-1 is generated by a client request and a control command is transmitted from the client to the command processing object 212-1, the command processing object 212-1 is bound with the message converting process 220-1 to process the control command. If the message converting process exists and is executed, the command processing object 212-1 is bound with the message converting process 220-1 and transmits the control command to the message converting process 220-1.

Alternatively, if the message converting process 220-1 does not exist, a new message converting process is automatically executed by the CORBA, and the command processing object 212-1 is bound with the message converting process which was newly executed. The message converting process 220-1 also includes a message converting object 221-1.

To prevent the command processing process from being blocked while it processes the control command, the command processing object 212-1 asynchronously processes the command with the message converting object 221-1.

Preferably, the command converting object 212-1 transmits the control command to the message converting object 221-1 and can execute different control command for the transmission element without waiting until a respond is received from the message converting object 212-1. To asynchronously send and receive messages between the command processing object 212-1 and message converting object 221-1, the transmission can be implemented by using a call back service or event service of the CORBA.

Preferably, the control command, which is transmitted to the message converting object 221-1, is transmitted to the CORBA object 301-1, which is implemented in the system software of the transmission element 300-1. The CORBA object 301-1 then executes the control command and returns the result to the message converting object 221-1. A synchronous message transmission is executed between the message converting object 221-1 and transmission element 300-1.

The message converting process 220-1 is configured to automatically cease if there is no requirement from the command processing process 210 or transmission element 300-1 for a predetermined time, by using the function of the CORBA. This prevents deterioration of the execution of the CORBA based transmission element management system eliminating by a resource having additional processes.

The EMS 200 can manage a plurality of transmission elements, which are remotely connected using the CORBA, by transmitting the control command which is transmitted from the client through the command processing objects. The command processing objects are generated in each transmission element and message processes, which correspond to the respective command processing objects, and receiving returning of the result value of the control command execution.

Also the transmission, which comprises a transmission network, generates an alarm of an appropriate shape according to the generation of an erroneous operation, for example, data processing error. Preferably, the alarm is reported to the EMS 200 so that the EMS 200 can grasp and manage the operation state of the transmission element.

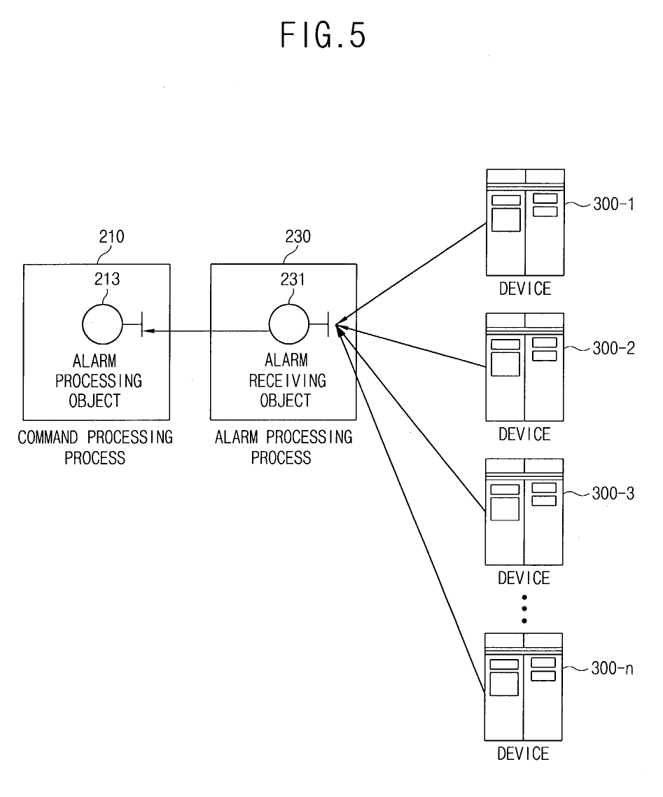

FIG. 5 is a drawing showing a structure of alarm processing of the EMS of the present invention. As shown in FIG. 5, the EMS 200 includes an alarm processing process 230 having an alarm receiving object 231. The alarm receiving object receives an alarm generated in respective transmission elements 300-1˜300-n, which are remotely connected through a channel. The transmission elements provide a notification service of the CORBA and a command processing process 210 having a command processing object 213 for processing the alarm, which is transmitted from the alarm processing process 230, and reporting it to the client.

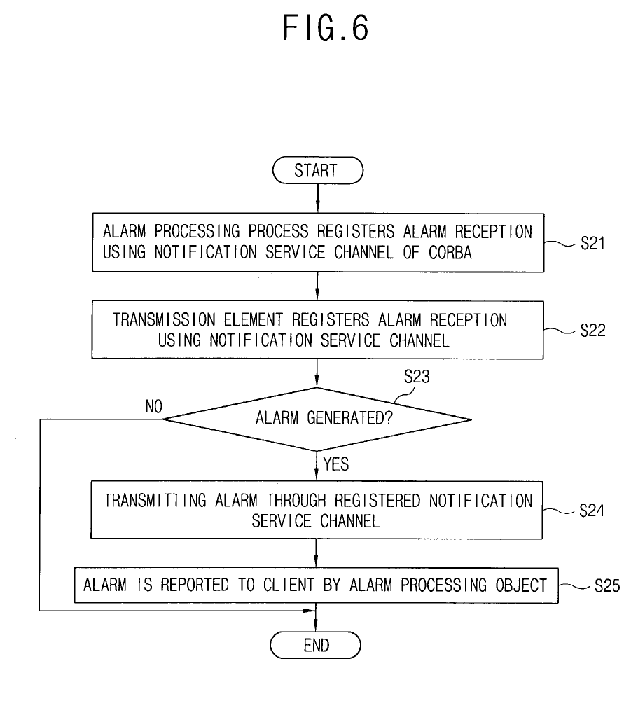

The alarm processing operation of the EMS 200 will be described with reference to FIG. 6. As shown in FIG. 6, the alarm processing object 213 of the command processing process 210 generates the alarm processing process 230. The alarm processing process 230 registers alarm reception to a channel which provides a notification service of the CORBA (S21). Also, the respective transmission elements 300-1˜300-n, which are remotely connected register alarm reception to the channel, provide the notification service (S22).

Preferably, when the alarm is generated in the respective transmission elements 300-1˜300-n, the transmission element, in which an alarm was generated, transmits the alarm information through the registered CORBA notification service.

Thus, the alarm processing process 230 of the EMS 200 receives the alarm information of the respective transmission elements through the registered notification service channel.

If the alarm information is received using the notification service of the CORBA, because the alarm processing process 230 does not need to continuously wait for reception of the alarm information from the transmission element, the alarm receiving object 231 of the alarm processing process 230 can asynchronously receive the alarm information reported from the transmission element (S23 and S24).

The alarm receiving object 231 preferably transmits the received alarm information to the alarm processing object 213 of the command processing process 210. The alarm processing object 213 then sends the transmitted alarm information to the client (S25).

As described above, the CORBA based transmission element management system and method thereof preferably generates a command processing object in each transmission element in which a plurality of control commands inputted from the client will be executed. The command processing object then generates the message converting process in each command converting process so that the respective control commands are executed in the corresponding transmission elements by using the command processing object and message converting process, and accordingly, the plurality of control commands are rapidly processed without blocking. Thus, the preferred embodiment of the present invention efficiently and stably manages the plurality of transmission elements which are remotely connected by one EMS, over the related art.

Also, by the present invention, an EMS can collect and process alarms of a plurality of transmission elements by receiving the plurality of alarms without blocking. Preferably, the EMS reports the alarms from a plurality of transmission elements, which are remotely connected to one EMS, using the channel for the notification service of the CORBA. Thus, preventing any blocking that occurred in the related art.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A Common Object Request Broker Architecture (CORBA) based transmission element management system, comprising:
a plurality of transmission elements configured to remotely connect in a CORBA; and
an Element Management System (EMS) generating a CORBA object in at least one of the plurality of transmission elements configured to execute a control command from a client, processing the control command by the CORBA object, and managing each of a plurality of transmission elements.

2. The system of claim 1, wherein the EMS includes:
a command processor configured to generate a command processing object, wherein the command processing object is configured to process and execute the control command in at least one of the plurality of transmission elements; and
a message converting process, which is generated in the command processing object, configured to generate a message converting object, wherein the message converting object is configured to convert the control command to a message recognizable by a corresponding transmission element and transmits the message to the corresponding transmission element.

3. The system of claim 2, wherein the EMS further includes:
an alarm processor having an alarm receiving object configured to receive alarms generated in the plurality of transmission elements connected remotely through a channel providing a notification service of the CORBA; and
an alarm processing object configured to process the alarms transmitted from the alarm receiving object and reporting the alarms to the client.

4. A Common Object Request Broker Architecture (CORBA) based transmission element management method, comprising:
receiving a command from a client;
processing the command from the client using the CORBA in at least one of a plurality of transmission elements in which the command from the client will be executed; and
reporting a command execution result to the client when the command execution result is returned from at least one of the plurality of transmission elements.

5. The method of claim 4, wherein the method of processing the command further comprises:
generating a command processing object in each of the plurality of transmission elements in which the command will be executed;
transmitting the command from the command processing object to a message conversion process;
converting the command to a message which can be recognized by a corresponding transmission element; and
transmitting the converted message from the message converting process to a corresponding transmission element.

6. The method of claim 5, wherein the message converting process is registered in an implementing repository of the CORBA so that the message converting process can be generated corresponding to the command processing objects.

7. The method of claim 5, wherein the message converting process automatically stops if there is no transmission request from the command processing object for a predetermined time.

8. The method of claim 5, wherein an asynchronous transmission method is performed between the command processing object and the message converting process.

9. A Common Object Request Broker Architecture (CORBA) based transmission element management method, comprising:
generating a command processing CORBA object in each of a plurality of transmission elements in which a request will be executed when the request for managing the plurality of transmission elements is received from a client to a command processor;
transmitting a command information attached to the command processing from the client to the command processing CORBA object;
transmitting the command information from the command processing CORBA object to a message converting process;
transmitting the command information from the message converting process to a corresponding transmission element by converting the command information into a message which can be recognized by the corresponding transmission element; and
reporting to the client when the command execution result value is returned from the corresponding transmission element.

10. The method of claim 9, wherein the message converting process is registered in an implementing repository of the CORBA so that it can be generated corresponding to the command processing CORBA objects one to one.

11. The method of claim 9, wherein the message converting process automatically stops if there is no transmission request from the command processing CORBA object and corresponding transmission element for a predetermined time.

12. The method of claim 9, wherein an asynchronous transmission method is performed between the command processing object and the message converting process.

13. The method of claim 9, further comprising the steps of:
receiving alarms generated in a plurality of transmission elements which are remotely connected through a channel configured to provide a notification service of the CORBA; and
reporting the alarm to the client in the command processing process by processing the received alarm.
